(19) United States
(12) Patent Application Publication
(10) Pub. No.: US 2019/0143992 A1
(43) Pub. Date: May 16, 2019

(54) SELF-DRIVING LEARNING APPARATUS AND METHOD USING DRIVING EXPERIENCE INFORMATION

(71) Applicant: Electronics and Telecommunications Research Institute, Daejeon (KR)

(72) Inventors: Joo Chan SOHN, Daejeon (KR); Kyoung Wook MIN, Sejong-si (KR); Jeong Dan CHOI, Daejeon (KR)

(73) Assignee: Electronics and Telecommunications Research Institute, Daejeon (KR)

(21) Appl. No.: 15/869,712

(22) Filed: Jan. 12, 2018

(30) Foreign Application Priority Data
Nov. 13, 2017 (KR) 10-2017-0150562

(51) Int. Cl. B60W 40/09; G05D 1/02; G05D 1/00; B60W 30/18

(52) U.S. Cl. CPC B60W 40/09; G05D 1/0221; G05D 2201/0213; G05D 1/0214; B60W 30/18009; G05D 1/0088

(57) ABSTRACT

The present invention relates to a self-driving learning apparatus and method using driving experience information. The self-driving learning apparatus includes: an environment information collecting sensor configured to collect driving environment information of a traveling vehicle; a control information collecting sensor configured to collect behavior control information of the traveling vehicle; and a self-driving information generator configured to generate driving experience information by matching driving environment information of a driving environment changing around an ego vehicle to the collected behavior control information.

### CROSS-REFERENCE TO RELATED APPLICATION

This application claims priority to and the benefit of Korean Patent Application No. 10-2017-0150562, filed on Nov. 13, 2017, the disclosure of which is incorporated herein by reference in its entirety.

### BACKGROUND

### 1. Field of the Invention

The present invention relates to a self-driving learning apparatus and method using driving experience information, and more particularly, to a self-driving learning apparatus and method using driving experience information which collect environment information necessary for self-driving and self-driving experience information from a vehicle being manually driven by a driver and apply the collected information to a self-driving system.

### 2. Discussion of Related Art

An automatic driving system (hereinafter referred to as a “self-driving system”) of a vehicle consists of a driving environment recognition system, a situation determination system, and a control system.

Such a conventional self-driving system is implemented on the basis of a scenario or usage example designed in advance through an actual long-term driving test or a computer simulation.

The conventional self-driving system implemented in the above-described manner determines a driving situation and establishes a driving strategy based on a scenario or usage example given for longitudinal and lateral control, such as lane keeping, lane changing, left/right turning, accelerating/decelerating, and the like.

Thus, a method of the conventional self-driving system for various longitudinal and lateral speed and direction controls, such as lane changing, left/right turning, accelerating/decelerating, and the like, is operated only when a current driving situation matches a condition (scenario or usage example) designed in advance by a system developer.

The conventional self-driving system is disadvantageous in that a road environment that reflects structural characteristics of a road, such as a road surface/grade/curvature in accordance with regulations and a vehicle operating environment in each region and/or each country, driving etiquette that varies by country and/or continent, safe driving skills that are suitable for characteristics of each type of vehicle, such as a width/height of a sedan/sport utility vehicle (SUV)/compact car or the like, and safe driving skills in consideration of road conditions due to seasonal/time-dependent climate change are not reflected.

In a case in which the conventional self-driving system intends to implement safe, passenger-convenient self-driving in accordance with a driving environment and a situation in which a variety of the above-described variables are generated, there is a problem in that pre-design by the system developer is not possible due to a broad implementation range of the self-driving.

### SUMMARY OF THE INVENTION

According to one aspect of the present invention, the present invention is devised to solve the above-described problems, and an objective of the present invention is to provide a self-driving learning apparatus and method using driving experience information to implement a self-driving vehicle that travels in various road driving environments, wherein the self-driving learning apparatus and method allow characteristics of the various road driving environments, which are difficult to reflect in a development process, to be reflected in a self-driving system by collecting driving experience information of a real human driver in advance and analyzing and learning the driving experience information.

In addition, the present invention provides a self-driving learning apparatus and method using driving experience information of a human driver, which can implement a safe self-driving vehicle with high passenger satisfaction.

Further, the present invention is to provide a self-driving learning apparatus and method for implementing a safe self-driving system of a self-driving vehicle with high passenger satisfaction in various driving environments that are not designed in advance by analyzing and learning driving experience data obtained from a human driver's driving or self-driving of a self-driving vehicle during behavior control of the self-driving vehicle.

The present invention is not limited hereto, and other objectives not described above may be more clearly understood from what is set forth below.

In one general aspect, there is provided a self-driving learning apparatus using driving experience information including: an environment information collecting sensor configured to collect driving environment information of a traveling vehicle; a control information collecting sensor configured to collect behavior control information of the traveling vehicle; and a self-driving information generator configured to generate driving experience information by matching driving environment information of a driving environment changing around an ego vehicle to the collected behavior control information.

The driving environment information may include at least one of moving status information of a dynamic obstacle on a road on which the vehicle travels, visible or non-visible signal information such as moving direction information to be conveyed to a nearby vehicle from dynamic and stationary obstacles, road structure information, information of a sign on a road surface, traffic sign information, and traffic signal information.

The behavior control information may be longitudinal and lateral control information which includes at least one of lane change information, acceleration and deceleration information, and left and right turn information.

The driving environment information may include at least one of vehicle type information, detailed road map information for self-driving including curvature/grade/lane information, road surface condition information, and climate information of a region in which the vehicle travels. The driving experience information may be composed of behavior information of the ego vehicle and behavior information of a nearby vehicle. The driving experience information may be behavior determination information for a longitudinal or lateral motion during accelerating/decelerating, lane keeping, lane changing, maintaining a vehicle-to-vehicle distance, merging, exiting, and passing an intersection. The behavior information of the ego vehicle may include longitudinal/lateral direction control data, information about a distance to the nearby vehicle, and lane occupancy information.

The behavior information of the nearby vehicle may include at least one of longitudinal direction behavior data, lateral direction behavior data, lane occupancy information, lateral direction indicator lamp information, and brake lamp information of the nearby vehicle recognized by an environment information collecting sensor of the ego vehicle.

The driving experience information may further include one or more pieces of information specified for each vehicle type, each road characteristic, each driving situation, and each driver characteristic.

In another general aspect, there is provided a self-driving learning method using driving experience information including: collecting, by an environment information collecting sensor, driving environment information of a traveling vehicle; collecting, by a control information collecting sensor, behavior control information of the traveling vehicle; and generating, by a self-driving information generator, driving experience information by matching driving environment information of a driving environment changing around an ego vehicle to the collected behavior control information.

The driving environment information may be stationary and dynamic driving environment information, such as moving status information of a dynamic obstacle on a road on which the vehicle travels, visible or non-visible signal information such as moving direction information to be conveyed to a nearby vehicle from dynamic and stationary obstacles, road structure information, information of a sign on a road surface, traffic sign information, and traffic signal information, and road status according to characteristics of a region in which the vehicle travels.

The behavior control information may be longitudinal and lateral control information which includes lane change information, acceleration and deceleration information, and left and right turn information.

The driving environment information may be vehicle type information, detailed road map information for self-driving including curvature/grade/lane information, road surface condition information, and climate information of a region in which the vehicle travels.

The driving experience information may be behavior determination information for a longitudinal or lateral motion during accelerating/decelerating, lane keeping, lane changing, maintaining a vehicle-to-vehicle distance, merging, exiting, and passing an intersection.

The driving experience information may further include one or more pieces of information specified for each vehicle type, each road characteristic, each driving situation, and each driver characteristic.

The driving experience information may be composed of behavior information of the ego vehicle and behavior information of a nearby vehicle.

The behavior information of the ego vehicle may include longitudinal/lateral direction control data, information about a distance to the nearby vehicle, and lane occupancy information.

The behavior information of the nearby vehicle may include at least one of longitudinal direction behavior data, lateral direction behavior data, lane occupancy information, lateral direction indicator lamp information, location information, and brake lamp information of the nearby vehicle recognized by an environment information collecting sensor of the ego vehicle.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration diagram for describing a self-driving learning apparatus using driving experience information according to one embodiment of the present invention;

FIG. 2 is a diagram for describing a self-driving learning apparatus using driving experience information according to one embodiment of the present invention;

FIG. 3 is a diagram for describing a self-driving learning apparatus using driving experience information according to one embodiment of the present invention;

FIG. 4 is a flowchart for describing a self-driving learning method using driving experience information according to one embodiment of the present invention; and

FIG. 5 is a flowchart for describing a self-driving learning method using driving experience information according to one embodiment of the present invention.

### DETAILED DESCRIPTION OF EXEMPLARY EMBODIMENTS

Advantages and features of the present invention and methods of achieving the same will become apparent with reference to the embodiments described in detail below with reference to the accompanying drawings. However, the present invention is not limited to the embodiments described below and various modifications may be made thereto. The embodiments are merely provided to thoroughly disclose the invention and to convey the gist of the invention to one of ordinary skill in the art. The present invention is defined by the appended claims. The terminology used herein is for the purpose of describing particular embodiments only and is not intended to limit the invention. As used herein, the singular forms “a,” “an,” and “the” are intended to include the plural forms as well, unless the context clearly indicates otherwise. It should be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

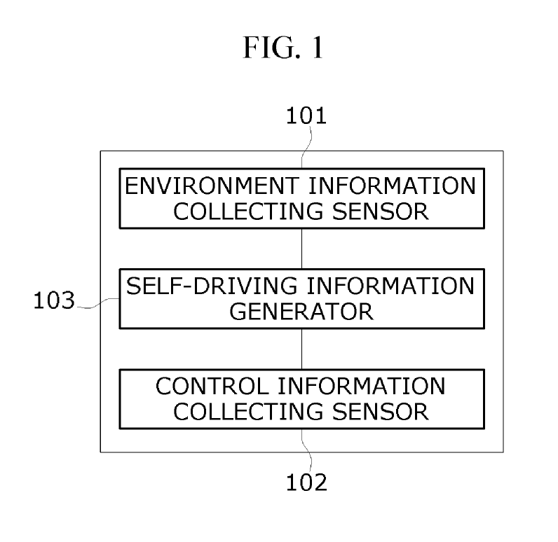

FIG. 1 is a configuration diagram for describing a self-driving learning apparatus using driving experience information according to one embodiment of the present invention.

As shown in FIG. 1, the self-driving learning apparatus using driving experience information according to one embodiment of the present invention includes an environment information collecting sensor 101, a control information collecting sensor 102, and a self-driving information generator 103.

The environment information collecting sensor 101 collects driving environment information of a traveling vehicle. The environment information collecting sensor 101 may preferably be configured as a device, such as a camera, a radar device, or a lidar device, which is capable of sensing dynamic movements of vehicles to the front, rear, left, and right of the traveling and static obstacles in all directions.

However, since the present invention is directed to a method of massively collecting driving experience information of a plurality of unspecified drivers within a short period of time through sensors, such as cameras, which are installed in typical vehicles driven by general people as well as in dedicated vehicles for the purpose of collecting environment information, the environment information collecting sensor is not necessarily configured by a combination of specific devices, such as a camera, a radar device, and a lidar device.

In this case, the driving environment information employed in the embodiment of the present invention may include at least one of information on a vehicle type of a nearby vehicle identified through a full length and an overall height thereof, detailed road map information for self-driving including curvature/grade/lane information, road surface condition information, and climate information of a region in which the vehicle travels. Here, the detailed road map information, the road surface condition information, the climate information, and the like are preferably received from an external server through wireless communication (not shown), but may be acquired through the environment information collecting sensor 101.

In addition, the control information collecting sensor 102 collects behavior control information of the traveling vehicle. The control information collecting sensor 102 is a sensor which is provided inside a vehicle which is controlled by a driver or self-driving information for acquiring longitudinal and lateral control information of the vehicle.

Here, the behavior control information employed in the embodiment of the present invention is longitudinal and lateral control information which includes at least one of lane change information, acceleration and deceleration information, and left and right turn information.

In addition, the self-driving information generator 103 generates driving experience information by matching information of a driving environment changing around an ego vehicle to the behavior control information. Here, the driving experience information employed in one embodiment of the present invention is preferably behavior determination information for a longitudinal or lateral motion during accelerating/decelerating, lane keeping, lane changing, maintaining a vehicle-to-vehicle distance, merging, exiting, and passing an intersection.

According to the embodiment of the present invention, the driving experience information is generated in a traveling vehicle by matching the driving environment information to behavior control information of an ego vehicle controlled by a driver so that a self-driving system can be trained with the driving experience information.

Thus, the present invention allows environment information with various variables acquired in an actual driving situation, rather than in a self-driving system using a scenario or usage example designed in advance by a system developer, to be applied to a self-driving system.

Meanwhile, the driving environment information employed in the embodiment of the present invention preferably includes at least one of moving status information of a dynamic obstacle on a road on which the vehicle is traveling (nearby vehicle information, nearby moving two-wheeled object information, and nearby pedestrian information), visible or non-visible signal information such as moving direction information to be conveyed to a nearby vehicle from dynamic and stationary obstacles, road structure information, information of a sign on a road surface, traffic sign information, and traffic signal information.

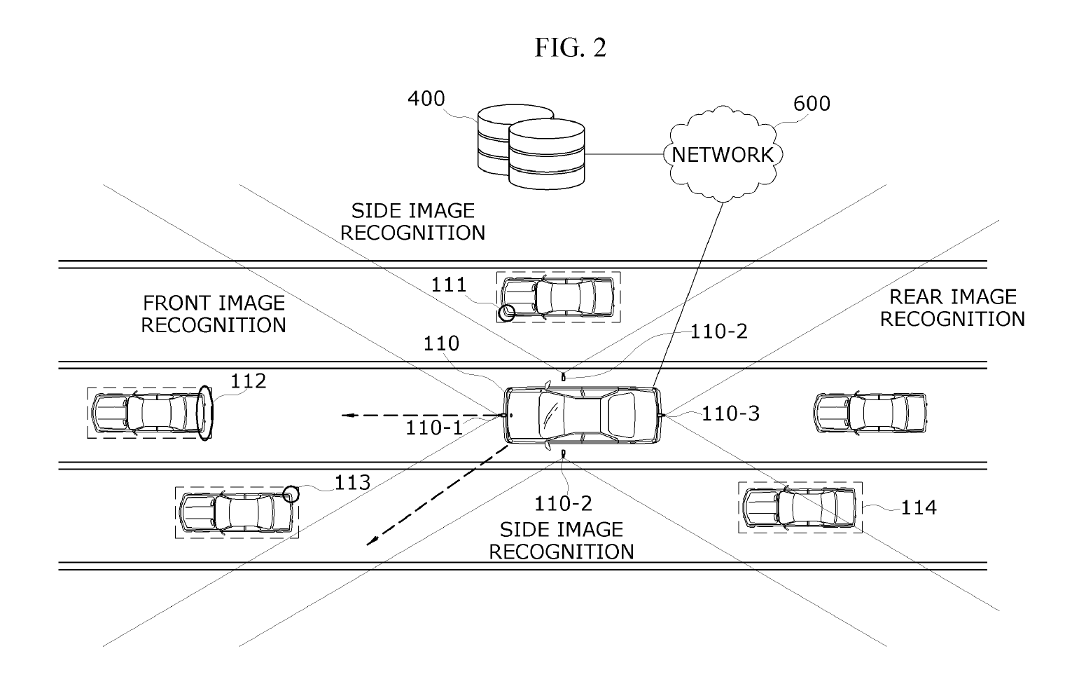

FIG. 2 is a diagram for describing a self-driving learning apparatus using driving experience information according to one embodiment of the present invention. An environment information collecting sensor 101 employed in one embodiment of the present invention collects behavioral conditions, such as moving speeds, moving directions, and moving intentions of moving objects 111 to 114 on a road, that is, driving environment information, as shown in FIG. 2. To this end, the environment information collecting sensor 101 may be preferably installed at a front side 110-1, left and right sides 110-2, and a rear side 110-3 of a vehicle.

Accordingly, the environment information collecting sensor 101 recognizes the presence, type, and behavioral characteristic of a moving object located in a traveling direction of an ego vehicle, a lane occupied by the moving object, and a distance between the ego vehicle and the moving object.

In addition, the environment information collecting sensor 101 collects driving environment information about a brake lamp of a vehicle 112 traveling ahead of the ego vehicle in the same lane, a right indicator lamp of a vehicle 113 traveling ahead of the ego vehicle in a first lane, and a left indicator lamp of a vehicle 111 traveling alongside the ego vehicle in a third lane. Accordingly, the environment information collecting sensor 101 may identify a behavioral intention of the vehicle traveling ahead of the ego vehicle by recognizing lighting of the brake lamp and lighting of the right indicator lamp of the vehicles 112 and 113 moving ahead of the ego vehicle.

For example, when the brake lamp of the object 112 moving ahead of the ego vehicle is recognized and a distance from an ego vehicle 110 is decreased, a driver of the ego-vehicle may step on a brake pedal to secure a safe distance to the front vehicle, or, according to circumstances, the driver may perform longitudinal and lateral control of the ego vehicle through a steering wheel maneuver while accelerating to move to an empty left or right lane in which a nearby traveling vehicle is sufficiently distant.

In addition, when the vehicles 111 and 113 traveling alongside or in front of the ego vehicle in the right or left lane flash the lane changing lamps to move to a lane in which the ego vehicle 110 is traveling, the ego vehicle 110 may decelerate or move to an empty left or right lane by longitudinal and lateral control according to a traveling status of a nearby vehicle 114.

In addition, the environment information collecting sensor 101 may collect traveling environment information, such as road structure information, information about a sign on a road surface, traffic sign information, traffic signal information, and the like.

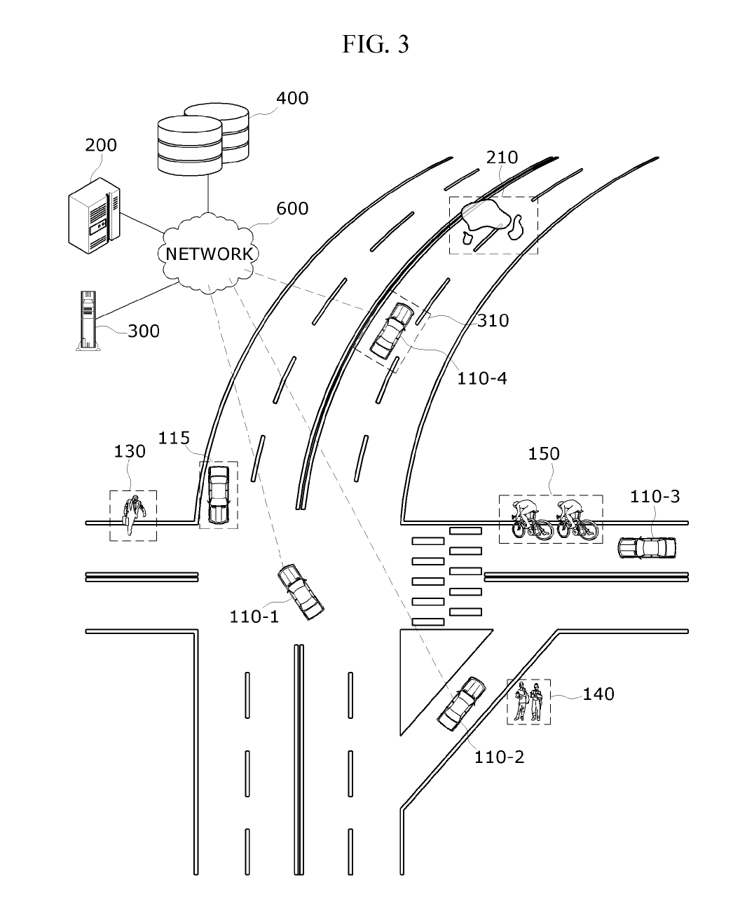

FIG. 3 is a diagram for describing a self-driving learning apparatus using driving experience information according to one embodiment of the present invention. As shown in FIG. 3, a driver controls a vehicle in a manner appropriate to structural characteristics of a road, such as a road surface condition 210, a gradient and curvature 310, and a vehicle type according to a weather environment while driving.

In addition, a characteristic of a surrounding environment of the road, such as an urban road, a suburban road, or a road with many moving objects other than vehicles, is also a factor that affects a driving method (longitudinal and lateral control) of the vehicle.

In the case of a road having a lot of pedestrians 130 traversing the road and a road having many moving non-vehicle objects, such as two-wheeled bikes 150, it is necessary to fully stop or slow down when a pedestrian is found, provide a minimum distance or yield to a two-wheeled bike to secure safety thereof, and give priority to a left-turning vehicle to enter a lane.

In addition, there may be various driving methods that must comply with driving culture and laws which may vary by region or country. For example, driving instructions related to stopping and slowing down when a pedestrian is found walking or waiting on a road or a crosswalk, priority among left-turning and right-turning vehicles at various types of intersections, and a legal safe distance to a two-wheeled bike may vary by region or country.

The present invention obtains driving experience information (longitudinal and lateral control data) and driving environment information for training a self-driving vehicle which must safely travel in various road environments and road weather environments and comply with a driving culture and traffic regulations which vary by region or country.

Obtained driving experience information and driving environment information may be stored in a driving experience database (DB) 400 through an external network 600 by being matched according to a driving time and a region through which the vehicle travels.

In the driving experience DB 400, road weather information and road attribute information acquired from a road weather information server 200 and a driving map server 300 may be stored by being matched to information and behavior data (longitudinal and lateral control) of a driving experience acquiring vehicle 110-4 according to time and section.

In addition, the driving experience information is preferably composed of behavior information of an ego vehicle and behavior information of a nearby vehicle. Here, the behavior information of the ego vehicle is longitudinal/lateral direction control data, information about a distance to the nearby vehicle, and lane occupancy information, and the behavior information of the nearby vehicle is longitudinal direction behavior data, lateral direction behavior data, lane occupancy information, lateral direction indicator lamp information, and brake lamp information of the nearby vehicle recognized by the environment information collecting sensor 101 of the ego vehicle.

Therefore, the self-driving information generator 103 according to one embodiment of the present invention generates driving experience information during a behavior determination which may be made while the vehicle is being driven. Accordingly, characteristics of behavior information of nearby vehicle information which affect the behavior of the ego vehicle are extracted by analyzing the driving experience information without coding a self-driving system algorithm, and the characteristics are matched with the behavior information of the ego vehicle while the ego vehicle is being driven, thereby making it possible to learn the self-driving system algorithm.

In addition, according to one embodiment of the present invention, the driving experience information may further include one or more pieces of information specified for each vehicle type of ego vehicles and nearby vehicles, each road characteristic, each driving situation, and each driver characteristic. A road detail map including road propriety information, such as a curvature, a grade, a lane, and the like of a road, may be received from an external map server, and the driving experience information may be matched with a driving method of a driver for each road characteristic. To this end, the present invention may further include a wireless communication system for wireless network communication with the external map server.

As described above, according to one embodiment of the present invention, pieces of information received through the external server and the driving environment information collected through the environment information collecting sensor are included in the driving experience information so that more accurate driving experience information which is not reflected when developing or training a conventional self-driving system can be acquired advantageously.

As described above, according to one embodiment of the present invention, a driving experience is learned through a learning process, a parameter, a decision condition, and a longitudinal and lateral control value which are related to a behavior control of an ego vehicle are adjusted by being compared with surrounding driving situation information that changes during actual road driving, a variety of pieces of road environment information, and driving experience information used in learning, and thereby a variety of self-driving processes, such as lane keeping, maintaining of a vehicle-to-vehicle distance, lane changing, accelerating/decelerating in consideration of a structural characteristic of a road, acquiring safe driving skills on a busy road, and the like can be performed.

According to the present invention, behavior data of a driving experience information acquiring vehicle for each time point and each road section may be learned in association with road weather data and driving map data for each time point and each road section.

Therefore, according to the present invention, a system developer can easily develop a self-driving system without needing to thoroughly analyze road conditions and structural characteristics of a road, which vary by region and time, or design a complicated algorithm corresponding to the analysis result.

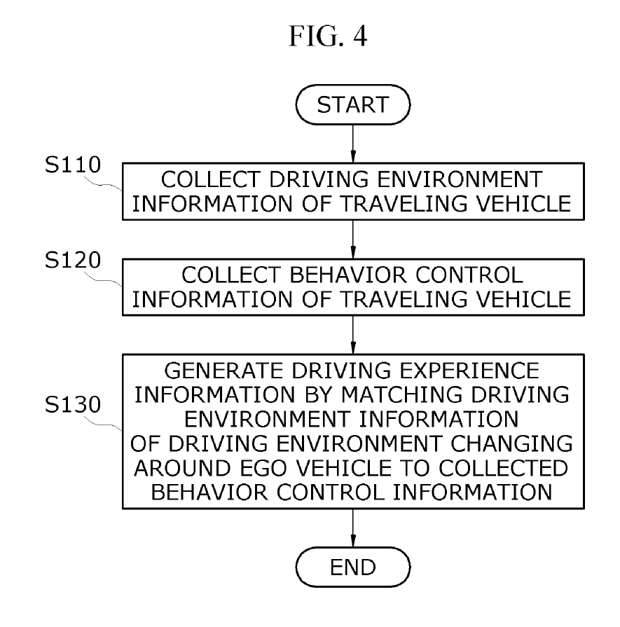

Hereinafter, a self-driving learning method using driving experience information according to one embodiment of the present invention will be described with reference to FIG. 4.

The self-driving learning method using driving experience information according to one embodiment of the present invention is preferably performed by a self-driving learning apparatus installed in a vehicle capable of driving.

First, the environment information collecting sensor 101 collects driving environment information of a traveling vehicle (S110).

Then, the control information collecting sensor 102 collects behavior control information of a traveling ego vehicle (S120).

Then, the self-driving information generator 103 generates driving experience information by matching information of a driving environment changing around the ego vehicle to the behavior control information (S130).

According to one embodiment of the present invention, the driving experience information is generated by matching the driving environment information to the behavior control information of the driver so that the driving experience information can be used for self-driving learning.

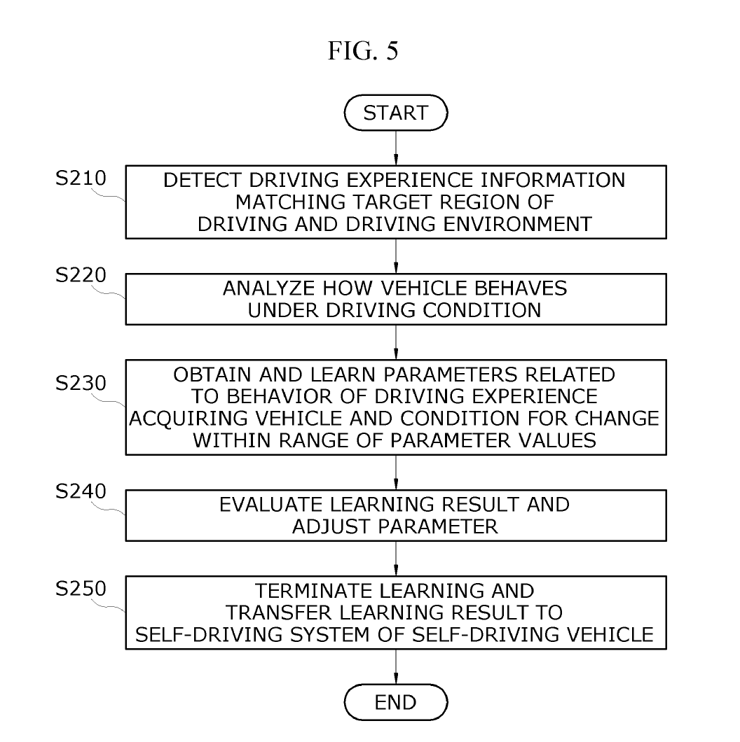

Hereinafter, a self-driving learning method using driving experience information according to one embodiment of the present invention will be described with reference to FIG. 5. Since the self-driving learning method using driving experience information has to undergo a process of verifying a driving safety of a learning result, it is preferable for driving experience information to be applied to a self-driving apparatus after a computer primarily learns the driving experience information and safety thereof is verified by comparing the learning result with the driving experience information.

First, a self-driving learning apparatus detects behavior information of an ego vehicle and driving environment information, which match a target region for self-driving and a driving environment of the target region, from driving experience information (S210), and then the self-driving learning apparatus compares and analyzes the behavior information of the ego vehicle with the extracted driving environment information to analyze how the ego vehicle behaved in response to a change in a surrounding driving environment condition (S220).

Then, the self-driving learning apparatus analyzes and learns parameters for a driving environment condition related to the behavior of the ego vehicle, types of parameter values, and a change condition and a range of variation of a parameter that is considered to have affected the behavior of the ego vehicle (S230).

Then, in order to evaluate driving stability of the learning result, the self-driving learning apparatus evaluates the learning result using a computer simulation in which the behavior information of the ego vehicle presented by the self-driving learning result is compared with the behavior information of the ego vehicle included in driving experience information for a similar section or driving experience information used for learning, and the self-driving learning apparatus adjusts the parameter (S240).

Thereafter, the self-driving learning apparatus terminates the learning and transfers the learning result to a self-driving system of a self-driving vehicle when a driving stability level set as an objective of the learning is reached, and the self-driving learning apparatus repeats the learning process when the target driving stability level is not reached (S250).

According to another embodiment of the present invention, driving experience information including a driving method of an actual driver is learned as self-driving control information so that a self-driving system of a driving mode of a human driver, which cannot be provided by a conventional self-driving system that controls self-driving according to a condition (scenario or usage example) designed in advance by a conventional system developer, can be easily provided.

For example, referring to FIG. 2, in the case of a lane change to a right lane, when a right-side vehicle 111 is traveling in the third lane, a driver of an ego vehicle may generally pass the right-side vehicle 111 or change to the right lane after the right-side vehicle 111 passes according to a habit of the driver.

According to the present invention, in a case in which the driver's habit on right lane change is to change lane after the right-side vehicle 111 passes, the self-driving system may perform self-driving such that the ego vehicle is slowed down and moves to the third lane, which is the right lane, after the right-side vehicle 111 passes. However, when vehicles are continuously traveling on the right lane behind the ego vehicle, the ego vehicle may stay in its current lane without changing lanes and keep driving until a condition for changing lanes is satisfied. In addition to the above-described examples of passing, referring to FIG. 2, in a case in which the right-side vehicle 111 expresses a behavioral intention to cut between the ego vehicle 110 and a vehicle 112 ahead of the ego vehicle 110 by using a direction indicator lamp, the ego vehicle may perform self-driving to change to the third lane after slowing down to allow the right-side vehicle to turn into the second lane. Such various types of lane changes are not determined only by behaviors of the ego vehicle and the right-side vehicle 111, and lane changing is performed in various ways according to behavioral conditions of nearby vehicles when acquiring the driving experience and a driving pattern of the driver.

However, a conventional self-driving system which is designed in advance by a system developer may be designed to pass the right-side vehicle 111 when moving into the right lane. In this case, the conventional self-driving vehicle may change lanes by passing the right-side vehicle 111 or may stay in a current lane until a condition for passing is satisfied according to the design of the self-driving system.

As described above, in the conventional self-driving system, a driver in the self-driving vehicle may feel uneasy since the self-driving method is different from a driving habit of the driver, while the present invention can provide a self-driving system which reflects a driving habit of a driver to provide psychological stability to the driver. Since, in addition to driving experience of the driver of the self-driving vehicle, driving experiences of a plurality of other drivers can be included in the driving experience DB 400 according to the present invention, a self-driving system having excellent driving stability for a region and a driving environment in which the driver has no driving experience can be provided. Also, by adjusting learning conditions and learning result performance evaluation parameters, it is possible to easily provide a self-driving system having a driving pattern which is preferred by the passenger or able to save fuel.

In the above description, a lane change is described, but the driving experience information may not be limited to such behavior determination information for driving, and may be applied to accelerating/decelerating, lane keeping, lane changing, maintaining of a vehicle-to-vehicle distance, merging, exiting, and passing of an intersection.

According to one embodiment of the present invention, in the development of a self-driving system, the self-driving system is trained on the basis of driving experience information which is generated during actual driving, and thus it is possible to effectively develop a self-driving system in which various factors, such as complicated surrounding driving situations in which numerous vehicles are traveling on a road, structural characteristics of a road, road weather conditions, region-specified driving regulations and etiquette, and the like, are reflected.

In addition, according to the present invention, as more driving experience information is accumulated, driving safety and driver satisfaction of the self-driving system can be further improved.

While the present invention has been particularly shown and described with reference to exemplary embodiments thereof, it should be understood by those of ordinary skill in the art that various changes in form and details may be made therein without departing from the spirit and scope of the present invention as defined by the following claims.

What is claimed is:

1. A self-driving learning apparatus using driving experience information comprising:
an environment information collecting sensor configured to collect driving environment information of a traveling vehicle;
a control information collecting sensor configured to collect behavior control information of the traveling vehicle; and
a self-driving information generator configured to generate driving experience information by matching driving environment information of a driving environment changing around an ego vehicle to the collected behavior control information.

2. The self-driving learning apparatus of claim 1, wherein the driving environment information includes at least one of moving status information of a dynamic obstacle on a road on which the vehicle travels, visible or non-visible signal information such as moving direction information to be conveyed to a nearby vehicle from dynamic and stationary obstacles, road structure information, information of a sign on a road surface, traffic sign information, and traffic signal information.

3. The self-driving learning apparatus of claim 1, wherein the behavior control information is longitudinal and lateral control information which includes at least one of lane change information, acceleration and deceleration information, and left and right turn information.

4. The self-driving learning apparatus of claim 1, wherein the driving environment information includes at least one of vehicle type information, detailed road map information for self-driving including curvature/grade/lane information, road surface condition information, and climate information of a region in which the vehicle travels.

5. The self-driving learning apparatus of claim 1, wherein the driving experience information is composed of behavior information of the ego vehicle and behavior information of a nearby vehicle.

6. The self-driving learning apparatus of claim 5, wherein the driving experience information is behavior determination information for a longitudinal or lateral motion during accelerating/decelerating, lane keeping, lane changing, maintaining a vehicle-to-vehicle distance, merging, exiting, and passing an intersection.

7. The self-driving learning apparatus of claim 5, wherein the behavior information of the ego vehicle includes at least one of longitudinal/lateral direction control data, information about a distance to the nearby vehicle, and lane occupancy information.

8. The self-driving learning apparatus of claim 7, wherein the behavior information of the nearby vehicle includes at least one of longitudinal direction behavior data, lateral direction behavior data, lane occupancy information, lateral direction indicator lamp information, and brake lamp information of the nearby vehicle recognized by the environment information collecting sensor of the ego vehicle.

9. The self-driving learning apparatus of claim 1, wherein the driving experience information further includes one or more pieces of information specified for each vehicle type, each road characteristic, each driving situation, and each driver characteristic.

10. A self-driving learning method using driving experience information comprising:
collecting, by an environment information collecting sensor, driving environment information of a traveling vehicle;
collecting, by a control information collecting sensor, behavior control information of the traveling vehicle; and
generating, by a self-driving information generator, driving experience information by matching driving environment information of a driving environment changing around an ego vehicle to the collected behavior control information.

11. The self-driving learning method of claim 10, wherein the driving environment information includes moving status information of a dynamic obstacle on a road on which the vehicle travels, visible or non-visible signal information such as moving direction information to be conveyed to a nearby vehicle from dynamic and stationary obstacles, road structure information, information of a sign on a road surface, traffic sign information, and traffic signal information.

12. The self-driving learning method of claim 10, wherein the behavior control information is longitudinal and lateral control information which includes lane change information, acceleration and deceleration information, and left and right turn information.

13. The self-driving learning method of claim 10, wherein the driving environment information is vehicle type information, detailed road map information for self-driving including curvature/grade/lane information, road surface condition information, and climate information of a region in which the vehicle travels.

14. The self-driving learning method of claim 10, wherein the driving experience information is behavior determination information for a longitudinal or lateral motion during accelerating/decelerating, lane keeping, lane changing, maintaining a vehicle-to-vehicle distance, merging, exiting, and passing an intersection.

15. The self-driving learning method of claim 14, wherein the driving experience information further includes one or more pieces of information specified for each vehicle type, each road characteristic, each driving situation, and each driver characteristic.

16. The self-driving learning method of claim 14, wherein the driving experience information is composed of behavior information of the ego vehicle and behavior information of a nearby vehicle.

17. The self-driving learning method of claim 16, wherein the behavior information of the ego vehicle includes at least one of longitudinal/lateral direction control data, information about a distance to the nearby vehicle, and lane occupancy information.

18. The self-driving learning method of claim 16, wherein the behavior information of the nearby vehicle includes at least one of longitudinal direction behavior data, lateral direction behavior data, lane occupancy information, lateral direction indicator lamp information, and brake lamp information of the nearby vehicle recognized by an environment information collecting sensor of the ego vehicle.
